(19) United States
(12) Patent Application Publication
(10) Pub. No.: US 2026/0310239 A1
(43) Pub. Date: Oct. 8, 2026

(54) System and Method for Protecting Solar Panels from Inclement Weather

(71) Applicant: John Bugardi, New York, NY (US)

(72) Inventor: John Bugardi, New York, NY (US)

(21) Appl. No.: 19/572,621

(22) Filed: Mar. 19, 2026

Related U.S. Application Data
(60) Provisional application No. 63/775,193, filed on Mar. 20, 2025.

(51) Int. Cl. G05D 3/10; G01S 13/95; G06V 20/52; H02S 20/30

(52) U.S. Cl. CPC G05D 3/10; G01S 13/95; H02S 20/30; G06V 20/52

(57) ABSTRACT

A solar panel positioning system includes at least one processor configured to perform operations including receive indications of inclement weather, and in response to at least one indication of inclement weather, perform further operations including: operate at least one actuator assembly to rotate at least one panel assembly comprising a solar panel and shield from at least one collection orientation that enables the solar panel to receive direct sunlight, and to a protective orientation that positions the shield above the solar panel to enable the shield to protect the solar panel from a falling object associated with the inclement weather; and maintain the at least one panel assembly in the protective orientation for at least a predetermined period of time before allowing the at least one panel assembly to be rotated out of the protective orientation.

### RELATED APPLICATION

This application claims the benefit of the priority date of U.S. Provisional Application 63/775,193 entitled “SYSTEM AND METHOD FOR PROTECTING SOLAR PANELS FROM INCLEMENT WEATHER” filed Mar. 20, 2025 by John Bugardi; the disclosure of which is incorporated herein by reference for all purposes.

### BACKGROUND

### 1. Technical Field

The present disclosure relates to protecting solar panels by rotating them between a collection orientation for collecting solar energy, and a protective orientation in which sheets of protective material are positioned above the solar panels to absorb and/or deflect impacts from hailstones and/or other falling objects associated with inclement weather.

### 2. Description of the Related Art

In recent years, the use of solar panels to generate electricity from solar energy emanating from the sun has become markedly more commonplace. A combination of motivations from the need to reduce climate-altering emissions to the need to reduce energy costs have come together with the increasing efficiency and decreasing costs of solar panels to make this form of electric power generation ever more desirable and viable. As a result, both large scale arrays of solar panels operated by utility companies and small scale arrays of solar panels operated by individual homeowners and businesses have become more rapidly commonplace.

After decades of development to improve their efficiency and other aspects of their design, the majority of current day solar panels are constructed as a “sandwich” of a combination of a sheet of tempered glass and a first sheet of EVA foam through which direct sunlight initially passes, a sheet of interconnected solar cells to capture a portion of that direct sunlight, and a combination of a second sheet of EVA foam and a backing sheet. Such a solar panel may be surrounded about its edges and supported by an aluminum frame that prevents bending of such a solar panel, and that enables the solar panel to be quickly and easily mounted for use. In the case of traditional “monofacial” solar panels, the backing sheet may be a sheet of white backing material that serves to reflect another portion of that direct sunlight that passed uncaptured through the sheet of interconnected solar cells back to the sheet of interconnected solar cells as reflected sunlight to provide another opportunity for capture.

The use of tempered glass as the exterior surface layer through which direct sunlight passes on the way to the interconnected sheet of solar cells has become an accepted commonplace feature of solar panel construction. While other materials have been considered as a substitute for glass, including various transparent plastics, the characteristics of direct sunlight have rendered most other materials unacceptable. In particular, most other transparent materials that have been considered are subject to yellowing and/or becoming less transparent (e.g., becoming translucent or opaque) over time from exposure to the ultraviolet (UV) component of sunlight. This would decrease the amount of the sunlight reaching the solar cells over time, thereby decreasing the amount of electricity generated over time.

Unfortunately, such use of glass renders solar panels more susceptible to damage from inclement weather. Since the capture of direct sunlight by the solar cells requires that the sheet of interconnected solar cells be oriented toward the sun, solar panels must necessarily be oriented with the sheet of tempered glass at an upwardly-facing angle.

This makes the sheet of tempered glass susceptible to damage from impacts from such objects as falling hailstones during a hail storm, as well as impacts from other falling objects that may have been lifted into the air by such weather events as severe wind gusts, hurricanes and tornadoes.

### BRIEF SUMMARY

Techniques are described for protecting solar panels from inclement weather by rotating them between a collecting position for collecting solar energy and a protective orientation in which sheets of protective material are positioned above the solar panels to absorb and/or deflect impacts from hailstones and/or other falling objects associated with inclement weather.

A solar panel positioning system includes at least one processor configured to perform operations including receive indications of inclement weather, and in response to at least one indication of inclement weather, perform further operations including: operate at least one actuator assembly to rotate at least one panel assembly comprising a solar panel and shield from at least one collection orientation that enables the solar panel to receive direct sunlight, and to a protective orientation that positions the shield above the solar panel to enable the shield to protect the solar panel from a falling object associated with the inclement weather; and maintain the at least one panel assembly in the protective orientation for at least a predetermined period of time before allowing the at least one panel assembly to be rotated out of the protective orientation.

A method includes receiving, by at least one processor of a solar panel positioning system, indications of inclement weather, and in response to at least one indication of inclement weather, performing further operations including: operating at least one actuator assembly to rotate at least one panel assembly comprising a solar panel and shield about a horizontal axis from at least one collection orientation that enables the solar panel to receive direct sunlight, and to a protective orientation that positions the shield above the solar panel to enable the shield to protect the solar panel from a falling object associated with the inclement weather; and maintaining the at least one panel assembly in the protective orientation for at least a predetermined period of time before allowing the at least one panel assembly to be rotated out of the protective orientation.

A solar panel positioning system including: at least one panel assembly including a solar panel and a shield, wherein the solar panel is of a generally elongate rectangular shape defining a collection surface to receive direct sunlight from which to generate electricity, the shield comprises a sheet of material also of a generally elongate rectangular shape and the shield extends in parallel to a back surface of the solar panel that is opposite to the collection surface; and a mounting frame comprising a horizontal component to which the at least one panel assembly is coupled for being supported above a support surface that is exposed to the sunlight, wherein the horizontal component is configured to be rotated together with the at least one panel assembly from at least one collection orientation that enables the solar panel to receive direct sunlight, and to a protective orientation that positions the shield above the solar panel to enable the shield to protect the solar panel from a falling object associated with the inclement weather.

### BRIEF DESCRIPTION OF THE DRAWINGS

The disclosure will be better understood and when consideration is given to the drawings and the detailed description which follows. Such description makes reference to the annexed drawings wherein:

FIGS. 1A and 1B, together, provide high level block diagrams of an example embodiment of a solar panel positioning system.

FIG. 2 provides an exploded perspective view of an example embodiment of a panel assembly of a solar panel and associated shield of the system of FIGS. 1A-B.

FIGS. 3A, 3B and 3C, together, present perspective views of differing example embodiments of mounting frames of the system of FIGS. 1A-B.

FIG. 4 provides a block diagram of an example embodiment of an actuator assembly of the system of FIGS. 1A-B.

FIGS. 5A, 5B, 5C and 5D, together, present elevational views of one example of interactions among mounting frames and actuator assemblies of the system of FIGS. 1A-B.

FIGS. 6A, 6B and 6C, together, present elevational views of another example of interactions among mounting frames and actuator assemblies of the system of FIGS. 1A-B.

### DETAILED DESCRIPTION

In the following detailed description, reference is made to the accompanying drawings that form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Disclosed herein is a system for protecting solar panels from inclement weather by rotating them between a collecting position for collecting solar energy and a protective orientation in which sheets of protective material are positioned above the solar panels to absorb and/or deflect impacts from hailstones and/or other falling objects associated with inclement weather.

A solar panel positioning system includes at least one processor configured to perform operations including receive indications of inclement weather, and in response to at least one indication of inclement weather, perform further operations including: operate at least one actuator assembly to rotate at least one panel assembly comprising a solar panel and shield from at least one collection orientation that enables the solar panel to receive direct sunlight, and to a protective orientation that positions the shield above the solar panel to enable the shield to protect the solar panel from a falling object associated with the inclement weather; and maintain the at least one panel assembly in the protective orientation for at least a predetermined period of time before allowing the at least one panel assembly to be rotated out of the protective orientation.

A method includes receiving, by at least one processor of a solar panel positioning system, indications of inclement weather, and in response to at least one indication of inclement weather, performing further operations including: operating at least one actuator assembly to rotate at least one panel assembly comprising a solar panel and shield about a horizontal axis from at least one collection orientation that enables the solar panel to receive direct sunlight, and to a protective orientation that positions the shield above the solar panel to enable the shield to protect the solar panel from a falling object associated with the inclement weather; and maintaining the at least one panel assembly in the protective orientation for at least a predetermined period of time before allowing the at least one panel assembly to be rotated out of the protective orientation.

A solar panel positioning system including: at least one panel assembly including a solar panel and a shield, wherein the solar panel is of a generally elongate rectangular shape defining a collection surface to receive direct sunlight from which to generate electricity, the shield comprises a sheet of material also of a generally elongate rectangular shape and the shield extends in parallel to a back surface of the solar panel that is opposite to the collection surface; and a mounting frame comprising a horizontal component to which the at least one panel assembly is coupled for being supported above a support surface that is exposed to the sunlight, wherein the horizontal component is configured to be rotated together with the at least one panel assembly from at least one collection orientation that enables the solar panel to receive direct sunlight, and to a protective orientation that positions the shield above the solar panel to enable the shield to protect the solar panel from a falling object associated with the inclement weather.

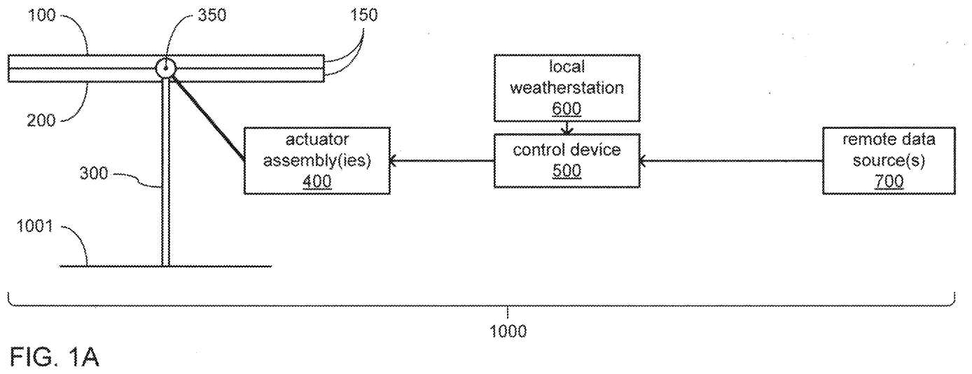

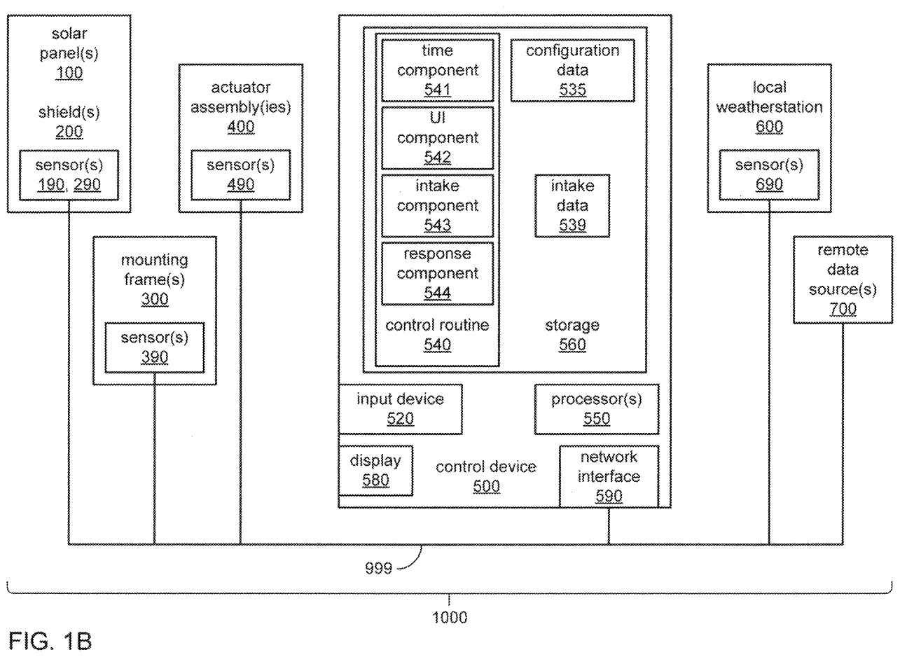

FIGS. 1A and 1B, taken together, provide a high level overall view of an example solar panel positioning system 1000 capable of taking action to protect a set of solar panels 100 from damaging effects of inclement weather. As depicted, the solar panel positioning system 1000 may include one or more of the solar panels 100 assembled together with one or more shields 200, one or more support frames 300, one or more actuator assemblies 400, a control device 500, a weather station 600, and/or one or more remote data sources 700. As will be explained in greater detail, upon receiving indications of incoming inclement weather and/or ongoing inclement weather in the vicinity of the solar panels 100, the control device 500 may operate the one or more actuator assemblies 400 to move panel assemblies 150 formed from combinations of the solar panels 100 and shields 200 into a position that enables the shields 200 to protect the solar panels 100.

Turning more specifically to FIG. 1A, the solar panels 100 and the shields 200 may be assembled back-to-back and in parallel together for being supported above a support surface 1001 (e.g., the ground, a paved surface, a concrete slab, etc.) by the one or more support frames 300. Such support about the ground may enable rotation of the panel assemblies 150 about a horizontal axis 350 above the support surface 1001. Such rotation about the axis 350 may be effected by the one or more actuator assemblies 400 as operated by the control device 500. The control device 500 may receive weather-related data from a local weather station 600 and/or from the one or more remote data sources 700. In response to the receipt of such data that is indicative of conditions that may damage the solar panels 100, the control device 500 may respond by operating at least one actuator assembly 400 to cause rotation of the panel assemblies 150 about the axis 350. Such rotation may be from a position in which the solar panels 100 are face upward in a direction for capturing sunlight for conversion into electrical energy, and to a position in which the shields 200 face upward, while the solar panels 100 are underneath the shields 200 while facing downward toward the support surface 1001. In this way, the solar panels 100 are protected from hailstones and/or falling debris that may have been carried aloft by winds associated with inclement weather (e.g., the winds of a hurricane or tornado).

Turning to FIG. 1B, as depicted, various components of the solar panel positioning system 1000 may be coupled to the control device 500 via network 999. As will shortly be explained, the network 999 may employ any of a variety of cabling-based and wireless communications technologies to convey data from a variety of sources to the control device 500, and/or to convey at least commands from the control device 500 to the one or more actuator assemblies 400.

As depicted, it may be that at least a subset of the solar panels 100 carry and/or otherwise incorporate one or more sensors 190, and/or that at least a subset of the shields 200 carry and/or otherwise incorporate one or more sensors 290. Each of the sensors 190 and/or 290 (if any of either one are present) may be any of a variety of types of sensor capable detecting any of a variety of conditions and/or capturing any of a wide variety of types of information. However, the relatively thin and wide physical nature of the solar panels 100 and/or the shields 200 (as will soon be explained in greater detail) may lend themselves well to cooperating with any of a variety of vibration, kinetic shock and/or acoustic sensors to detect the impact of such objects against the solar panels 100 and/or the shields 200 as hailstones, sleet, leaves and/or branches, loose amounts of dirt, etc. that may fall upon and/or be carried in the wind toward the panel assemblies 150. Although it may be deemed preferable to take action to protect the solar panels 100 in response to weather forecasts and/or other forms of weather data that are predictive of inclement weather that has not yet arrived in the vicinity of the solar panels 100, as those skilled in the art will readily recognize, it is not uncommon for inclement weather to occur suddenly in a particular localized area with little or no warning afforded by any weather forecast or other form of weather data. Instead, it may simply be that the occurrence of strikes against the solar panels 100 is the only way that potentially damaging inclement weather becomes known to have arrived, and/or it may simply be that the occurrence of strikes against the shields 200 is the only way that potentially damaging inclement weather is known to still be ongoing.

As depicted, it may be that one or more sensors 390 are mounted or otherwise carried by the one or more support frames 300, and/or are otherwise located about the one or more frames (e.g., affixed to the support surface 1001). Each sensor 390 (if any are present) may be any of a variety of types of sensor capable of detecting any of a variety of conditions and/or capturing any of a wide variety of types of information. However, by being positioned adjacent to where the panel assemblies 150 are mounted to the support frame(s) 300, it may be that ones of the sensor(s) 390 that include one or more cameras are advantageously positioned to capture images of the objects striking the solar panels 100 and/or the shields 200 of those panel assemblies 150. By way of example, images captured by cameras at such a location may be continuously analyzed using artificial neural networks (ANNs, such as convolutional neural networks trained for image processing) trained and used to recognize instances of objects falling down upon and/or otherwise striking the solar panels 100 and the shields 200. Not unlike the aforedescribed sensors 190 and/or 290, detecting occurrences of such strikes may provide useful indications that potentially damaging inclement weather is already occurring and/or is still ongoing.

As will be explained in greater detail, each of the one or more actuator assemblies 400 may be any of a variety of types of actuator (e.g., linear actuators, rotary actuators, etc.) that may be driven using any of a variety technologies (e.g., electrical energy, pneumatic pressure and/or vacuum, hydraulics, etc.). Accordingly, each of the one or more actuator assemblies 400 may each incorporate one or more sensors 490 to detect or confirm an extent of movement, detect instances of excess force or strain being exerted, detect or confirm that a particular position has been reached, etc. As will also be explained in greater detail, it may be that sensor(s) 490 within one or more of the actuator assemblies may aid in coordinating movement thereamong to rotate the panel assemblies 150 about the axis 350.

As will additionally be explained in greater detail, it may be that sensor(s) 490 within one or more of the actuator assemblies 400 may detect dynamically changing forces being exerted on the panel assemblies 150 by the wind, thereby enabling compensating actions and/or other actions to be taken as such rotation is being carried out.

As depicted, the local weatherstation 600 may incorporate one or more sensors 690 for detecting and/or measuring various aspects of the weather in the vicinity of the solar panels 100. Such aspects may include, and are not limited to, temperature, humidity, wind speed, wind direction, level of precipitation, type of precipitation, etc. Further, it may be that one of the sensors 690 is a radar system able to be used to detect various aspects of local wind movement and/or local precipitation, including patterns that are suggestive of the upcoming formation of local weather that may be damaging to the solar panels 100 and/or patterns indicative of such damaging local weather already being present. Still further, it may be that such a radar system is coupled to an ANN, agentic artificial intelligence (AI), or other form of machine learning that is able to recognize radar data indicative of flying debris that may have been driven aloft by inclement weather, and which may be approaching the solar panels 100.

In lieu of or in addition to the control device 500 receiving data about weather conditions and/or other conditions affecting the solar panels 100 from one or more locally positioned sensors 190, 290, 390, 490 and/or 690, the control device 500 may receive similar data from one or more remote data source(s) 700. More specifically, the control device 500 may receive information such as weather reports and/or warnings about specific instances of inclement weather via the network 999 from one or more remote servers that may be owned and/or operated by government and/or private industry weather organizations. Such weather information may include weather alerts in text form that may describe the location of current weather events using map coordinates, and may describe the weather events themselves with a combination of weather statistics. Alternatively or additionally, such weather information may include color coded radar images generated by processing data from radar stations at airports and/or other locations. Similar to the processing of weather related data that may be captured by one or more sensors 690 of the local weatherstation 600 (if present), various forms of machine learning may be used to analyze such data received from one or more remote data sources (e.g., ANNs, agentic AI, etc.) to recognize data that is indicative of an approaching (or already locally present) form of potentially damaging inclement weather.

Continuing with FIG. 1B, the control device 500 of the solar panel positioning system 1000 may include one or more processors 550, a storage 560, an input device 520 and/or a display 580, and/or one or more network interfaces 590. The processor(s) 550 may be communicatively coupled to others of these components via one or more buses and/or other form(s) of interconnect within the control device 500, to enable the exchange of executable instructions and/or data thereamong via the exchange of electrical, optical, magnetic and/or other transmissions. The storage 560 may store configuration data 535 and/or intake data 539. The storage 560 may also store control routine 540.

The processor(s) 550 may each be any of a wide variety of types of processor that are configured to perform instruction-based processing that entails the execution of sequences of instructions, including and not limited to central processing units (CPUs), graphics processing units (GPUs), microcontrollers, sequencers, etc. The processor(s) 550 may each incorporate any of a variety of features to enhance the speed and/or efficiency of processing operations. Such features may include and are not limited to, multi-threading support, multiple processing cores, single-instruction multiple-data (SIMD) support, directly integrated memory control functionality, and/or various modes of operation by which the speed of execution of instructions may be dynamically altered.

The storage 560 may be based on any of a variety of storage technologies that provide relatively high speeds of access, but which require the continuous provision of electric power to retain any data and/or routines stored therein. Such technologies may include, and are not limited to, random-access memory (RAM), dynamic RAM (DRAM), Double-Data-Rate DRAM (DDR-DRAM), synchronous DRAM (SDRAM), static RAM (SRAM), etc. Alternatively or additionally, the storage 560 may be based on any of a variety of storage technologies that may not be capable of providing such relatively high speeds of access, but which may be capable of storing with greater density, and/or capable of retaining data and/or routines stored therein regardless of whether electric power is continuously provided. Such technologies include, and are not limited to, read-only memory (ROM), erasable programmable ROM (EPROM), electrically erasable programmable ROM (EEPROM), flash memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array).

The input device 520 and the display 580, taken together, may provide a UI (e.g., a graphical user interface (GUI)) that enables manual interaction with the control device 500. The purposes for such manual interaction may include, and are not limited to: programming and/or adjusting aspects of the solar panel positioning system 1000 (e.g., as part of routine maintenance); testing various aspects of the system 1000; and/or manually overriding the system 1000 to manually reposition the panel assemblies 150.

The input device 520 may include one or more types of manual input device (e.g., various manually operable controls), including and not limited to, individual switches, buttons, knobs, etc. ; a keypad/keyboard; a pointing device (e.g., a mouse, a trackball, a touchpad, etc.); etc. Alternatively or additionally, the input device 520 may include one or more non-manual input devices (e.g., a barcode reader, a magnetic stripe reader, a radio-frequency identification (RFID) tag reader, etc.). In some embodiments, such a non-manual input device may be used to read commands encoded in barcodes and/or RFID tags that may trigger reset/initialization operations, may enable/effect adjustments, may update software routines, etc.

It should be noted that the display 580 may be a touchscreen display such that the display 580 is able to serve as both a visual output device and a manual input device, either in addition to or in lieu of, the control device 500 incorporating a separate and distinct input device 520. It should also be noted that the control device 500 may incorporate one or more components for presenting information in a non-visual manner, either in addition to or in lieu of, the control device 500 incorporating the display 580 (e.g., one or more speakers to present information audibly).

The network interface(s) 590 may be capable of employing any of a variety of wireless communications technologies that may be associated with the network 999. Such technologies may include, and are not limited to, radio frequency transmissions, transmissions incorporated into electromagnetic fields by which electric power may be wirelessly conveyed, and/or any of a variety of types of optical (e.g., infrared) and/or audio (e.g., ultrasonic) transmission. Additionally, the network interface 590 may be configured to engage in communications that adhere in timings, in protocols and/or in other aspects to one or more known and widely used standards, including and not limited to IEEE 802.11a, 802.11ad, 802.11ah, 802.11ax, 802.11b, 802.11g, 802.16, 802.20; Bluetooth; ZigBee; or a cellular radiotelephone service such as GSM with General Packet Radio Service (GSM/GPRS), CDMA/1xRTT, Enhanced Data Rates for Global Evolution (EDGE), Evolution Data Only/Optimized (EV-DO), Evolution For Data and Voice (EV-DV), High Speed Downlink Packet Access (HSDPA), High Speed Uplink Packet Access (HSUPA), 4G LTE, 5G, etc.

Alternatively or additionally, the network interface 590 may be capable of employing any of a variety of cabling-based communications technologies by which electrical and/or optical signals may be used to exchange information through any of a variety of electrical and/or optical cabling. Also alternatively or additionally, the network interface(s) 590 may be configured to engage in communications that adhere in timings, in protocols and/or in other aspects to one or more known and widely used standards, including and not limited to RS-232C, RS-422, Universal Serial Bus (USB), Ethernet (IEEE-802.3) or IEEE-1394.

Correspondingly, the network 999 may be implemented using any of a variety of wireless and/or cabling-based network technologies, including and not limited to, Bluetooth, Wi-Fi, cellular signaling, twisted-pair electrical cabling, coaxial electrical cabling, and/or fiber optic cabling. Such wireless and/or cabling-based technologies may adhere to any of a wide variety of specifications, including and not limited to, Ethernet and/or TCP/IP. In some embodiments, the network 999 may include, and/or may serve as a component of, the Internet. Thus, communications exchanged between the control device 500 and the remotely data source(s) 700 may be through a portion of the Internet. Further, in embodiments in which the control device 500 is located at a relatively lengthy distance from the solar panels 100, the communications exchanged between the control device 500 and other components of the solar panel positioning system 1000 that are co-located with the solar panels 100 may be through a portion of the Internet.

The configuration data 535 may store a variety of pieces of information concerning the solar panel positioning system 1000, including and not limited to: geographic location of the solar panels 100; angles above the horizontal plane and/or compass headings at which to aim the solar panels 100 at different times of a day, and/or at different days, weeks, months and/or seasons of a year to capture sunlight; minimum and/or maximum amounts of force, pressure, tension, etc. at which to operate the actuator assemblies 400 and/or associated components when repositioning the panel assemblies 150; minimum and/or maximum values for various weather statistics to use as thresholds for automated triggers to cause rotation of the panel assemblies 150 to protect the solar panels 100 thereof; etc. In embodiments in which machine learning is used to analyze received weather data, radar data and/or other data, the configuration data 535 may store ANN configuration data representing various aspects of triggering artificial neurons and/or various aspects of interconnections among artificial neurons (which may include the training of an ANN), and/or may store agentic AI configuration values and/or algorithms (which may include the training of an AI agent).

The intake data 539 may temporarily store data received from the sensors 190, 290, 390, 490 and/or 690, and/or data receive from the one or more remote data sources 700. The intake data 539 may be implemented as a first-in-first-out (FIFO) or ring buffer.

However, it may be that data associated with instances of the panel assemblies 150 being repositioned to protect the solar panels 100 thereof, and/or associated with instances in which received weather data triggered such repositioning (regardless of whether it was necessary) may be stored on a longer term basis to build up a long term record of the behavior of the solar panel positioning system 1000 over time for purposes of analysis and/or maintenance.

Still continuing with FIG. 1B, the control routine 540 may include instructions executable by the processor(s) 550 of the control device 500 to cause the processor(s) 550 to perform various functions. As previously discussed, among such functions may be receiving data indicative of incoming or currently ongoing inclement weather that is potentially damaging to the solar panels 100, and to respond to the receipt of such data by operating the one or more actuator assemblies 400 to rotate the panel assemblies 150 to a position in which the shields 200 thereof protect the solar panels 100 thereof from being struck by falling objects and/or objects carried aloft to the vicinity of the solar panels 100 as a result of that inclement weather.

As depicted, the control routine 540 may include a time component 541 including instructions, that when executed by the processor(s) 550, may cause the processor(s) 550 to maintain a clock and/or calendar marking the passage of time and/or to coordinate the timing for the performance of various other functions. By way of example, the processor(s) 550 may be caused to use the arrival of a particular time of a day, and/or the arrival of a particular day, week, month, season, etc. of a year may be used to trigger a repositioning of the solar panels 100 to be better aimed at the sun as its position in the sky relative to the solar panels 100 changes throughout each day and/or over the passage of each year.

Alternatively or additionally, in executing instructions of the time component 541, the processor(s) 550 may be caused by to load default timing values for various time delays that may be imposed in the performance of various operations. For example, it may be that the processor(s) 550 are caused to wait for a default amount of time (e.g., a hysteresis delay) after ceasing to receive data indicating either incoming or locally ongoing inclement weather before operating the one or more actuator assemblies 400 to reposition the panel assemblies 150 so that the solar panels 100 thereof once again face toward the sun to collect sunlight.

As depicted, the control routine 540 may include a UI component 542 including instructions, that when executed by the processor(s) 550, may cause the processor(s) 550 to operate the input device 520 and/or the display 580 (if either or both are present) to provide a user interface (e.g., a graphical user interface (GUI)) to enable at least some degree of manual operation of the solar panel positioning system 1000. By way of example, the processor(s) 550 may be caused to provide such a UI to: enable the system 1000 to be reset/initialized; enable configuration of various aspects of the system 1000 (e.g., change one or more settings away from default values that may have originally been retrieved from the configuration data 535); and/or to manually override aspects of the functionality of the system 1000 to manually trigger a repositioning of the panel assemblies 150 to use the shields 200 thereof to protect the solar panels 100 thereof from falling objects and/or objects carried aloft by associated with inclement weather.

As depicted, the control routine 540 may include an intake component 543 including instructions, that when executed by the processor(s) 550, may cause the processor(s) 550 analyze and interpret received data to recognize a potential for damage to the solar panels 100 from incoming or already ongoing inclement weather in the vicinity of the solar panels 100, and to make a determination of whether or not to operate the one or more actuator assemblies 400 to take action to protect the solar panels 100. As previously discussed, weather related data and/or data concerning potentially damaging conditions caused by inclement weather may be received from the sensor(s) 190, 290, 390, 490 and/or 690, and/or from the one or more remote data sources 700, and may be buffered within the storage 560 as part of the intake data 539, prior to analysis by the processor(s) 550.

As also previously discussed, such received data may take a variety of forms, including textual descriptions of weather conditions, raw numerical data indicative of various measured weather statistics, radar images in which may include color-coding for various aspects of weather (e.g., precipitation, wind movement, etc.). Where such data in the form of textual descriptions and/or numerical values is received, execution of the intake component 544 may cause the processor(s) 550 to parse that text and/or numerical values using various employ text recognition algorithms and/or statistical analysis algorithms (which may include large language models (LLMs) and/or other forms of machine learning) to recognize indications of inclement weather. Where such data includes radar imagery, the processor(s) 550 may be caused to interpret such imagery using various image analysis techniques (which may include ANNs and/or other forms of machine learning) to recognize indications of inclement weather and/or weather-triggered potential for damage to the solar panels 100.

As depicted, the control routine 540 may include a response component 544 including instructions, that when executed by the processor(s) 550, may cause the processor(s) 550 to operate at least one of the one or more actuator assemblies 400 to reposition the panel assemblies 150. As discussed just above, the act of moving the panel assemblies 150 may be triggered in connection with the processor(s) 550 executing instructions of any of the previously discussed components 541, 542 or 543. More specifically, such triggering may be caused by: 1) the processor(s) 550 determining (as a result of executing the time component 541) that the solar panels 100 are to be repositioned to be better aimed at the sun due to the time of day, and/or due to the day, week, month and/or season of the year; 2) the processor(s) 550 receiving instructions to move the panel assemblies 150 via the input device 520 and/or the display 580 (as a result of executing the UI component 542 to provide a UI); and/or 3) the processor(s) 550 determining (as a result of executing the intake component 543) that the panel assemblies 150 are to be repositioned to protect the solar panels 100 thereof from damage to due to inclement weather and/or are to be repositioned so that the solar panels 100 thereof once again face toward the sun due to the cessation of the potential for such damage.

It should be noted that, as an alternative to the processor(s) 550 being caused to operate at least one actuator assembly 400 rotating the panel assemblies 150 to a position the panel assemblies 150 in a protective orientation in which the solar panels 100 are caused to face downward toward a support surface 1001 to use the shields 200 to protect the solar panels 100, it may be that the processor(s) 550 are caused to so position the panel assemblies 150 in the same protective orientation to cause ice, sleet and/or snow to fall downward off of the solar panels 100. In a manner similar to triggering of such rotation in response to being caused by the intake component 543 to identify a potential for damage due to inclement weather, it may be that execution of the intake component 543 causes the processor(s) 550 to identify weather conditions in the vicinity of the solar panels 100 that may cause the solar panels 100 to be come covered with a layer of ice, sleet, snow, etc. that may reduce the amount of direct sunlight that reaches the solar panels 100 to a degree significant enough as to render the solar panels significantly or mostly incapable of collecting sunlight and converting it to electricity. The processor(s) 550 may be caused to determine that such weather conditions exist based on data received from the sensor(s) 690 of the local weatherstation 600 and/or from weather data received from remote data source(s) 700. Alternatively or additionally, it may be that one or more sensors 190 of one or more of the solar panels 100 detects temperature values and/or a pattern of temperature values over time that is consistent with coverage of the solar panels 100 with ice, sleet or snow. Also alternatively or additionally, the mounting frame(s) 300 may carry one or more sensors 390 that are able to capture data pertinent to the current condition of the solar panels 100, such as a camera able to capture images of the solar panels 100 that may be caused to be analyzed by execution of the intake component 543 by the processor(s) 550. It may be that at least part of such image analysis may entail the use of an ANN trained to recognize such a covering of the solar panels 100 (e.g., a convolutional neural network).

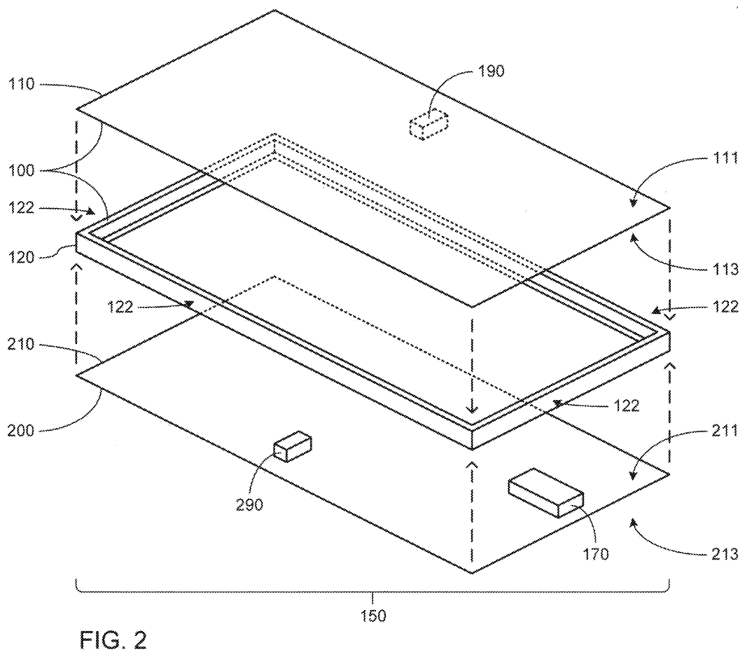

FIG. 2 provides an exploded perspective view of an example panel assembly 150 including just a single solar panel 100 and a single shield 200. The manner in which the depicted single solar panel 100 and single shield 200 are assembled together back-to-back and in parallel may be the same as was earlier depicted in FIG. 1A. More specifically, and as depicted, each solar panel 100 may be constructed in a manner somewhat similar to the aforementioned currently manufactured solar panels with a collection panel portion 110 that may be surrounded and supported at its edges by a frame portion 120. The collection panel portion 110 may be a typical “sandwich” of a sheet of tempered glass, sheets of EVA foam, a sheet of interconnected solar cells, and a sheet of white backing material, as earlier described. The frame portion 120 may be a typical aluminum frame, as also earlier described.

However, unlike currently manufactured solar panels, the depicted solar panel 100 may have the depicted shield 200, which as also depicted, may be in the form of a sheet of protective material (e.g., a sheet of steel, plastics material, fiberglass, etc.) that may also be surrounded and supported at its edges by the frame portion 120. With the collection panel portion 110 and the shield 200 so mounted to the frame portion 120, the resulting panel assembly 150 is given a relative flat and enclosed box-like shape. In this enclosed box-like shape, the tempered glass of the collection panel portion 110 may define the collection surface 111, the shield 200 may define the protective surface 213, and the frame portion 120 may define the depicted four edge surfaces 122 extending therebetween.

Thus, when the panel assembly 150 is rotated about the axis 350 (see FIG. 1A) to a position in a collection orientation for collecting sunlight, the direct sunlight that is received passes through the tempered glass that defines the collection surface 111 of the collection panel portion 110 of the solar panel 100, and reaches the sheet of solar cells therein to cause the generation of electricity. Accordingly, while multiple panel assemblies 150 are in such a collection orientation, the collection panel portions 110 thereof are susceptible to physical impacts by hailstones and/or other falling objects associated with inclement weather (e.g., objects caused to become airborne by strong wind gusts, hurricanes, tornadoes, etc.).

However, when the panel assembly 150 is rotated about the axis 350 (see FIG. 1A) to a position in a protective orientation for using the shield 200 to protect the solar panel 100 the protective surface 213 is caused to face upward, the collection surface 111 of each panel assembly 100 is correspondingly caused to face downward toward the support surface 1001. Accordingly, while the multiple panel assemblies 150 are in the protective orientation, each shield 200 is positioned above its corresponding solar panel 100 to protect that solar panel 100 from impacts caused by falling hailstones and/or other falling objects associated with inclement weather.

In the depicted example panel assembly 150, the shield 200 thereof may be a sheet of stainless steel. Testing and evaluation by Applicant has revealed that such a use of stainless steel may achieve a desirable combination of relatively low cost, relatively low weight, relative ease of attachment to the frame portion 120, and a relatively high resistance to denting from impacts of such falling objects as hailstones.

As will be familiar to those skilled in the art, like other electronic components, solar cells may function less efficiently when exposed to higher temperatures than when exposed to lower temperatures, including becoming less efficient at converting sunlight to electricity. As a result, it may be deemed desirable to form the frame portion 120 of the solar panel 100 to have apertures (e.g., perforations, slots, etc.) formed therethrough to enable airflow through parts of the frame portion 120 and between the collection panel portion 110 and the shield 120. Alternatively or additionally, the manner in which the shield 200 is mounted to the frame portion 120 may be chosen to deliberately leave gaps therebetween to allow airflow between the collection panel portion 110 and the shield 120.

As additionally depicted, and where the shield 200 is formed from a metallic material or other material that is thermally conductive, it may be that the shield 200 is also used to provide a heatsink for an electronic power device 170. In one variant, the electronic power device 170 may be a local inverter that converts the DC output of the collection panel portion 110 to AC with a sine wave that is synchronized to corresponding AC outputs of others of the solar panels 100. As will be familiar to those skilled in the art, conveying electric power as AC, instead of DC, is often considered safer and more efficient over lengthy distances. In particular, it is widely known that the manner in which the human body reacts to DC electric power during an electrocution event (instead of AC electric power) may greatly reduce chances of survival.

In another variant, the electronic power device 170 may be a DC current bypassing device that allows the current of the DC outputs of some solar panels 100 to bypass one or more other solar panels 100 that have ceased or substantially reduced their DC outputs as a result of an object (e.g., foliage or a tree branch, a person or vehicle, etc.) blocking direct sunlight from reaching a substantial portion of their collection panel portions 110. As will be familiar to those skilled in the art, where multiple solar panels are interconnected electrically in series, the amount of current that is able to flow therethrough may become limited by which solar panel receives the lowest amount of direct sunlight. With such a DC current bypassing device installed at each solar panel, the flow of current in such a situation is automatically bypassed around solar panels that are receiving such a low level of direct sunlight as to allow little to no current to flow therethrough.

In still another variant, the electronic power device 170 may be an electronic power safety shutoff device. As will be familiar to those skilled in the art, the recent sudden increase in installation and use of solar panels to generate electricity has sparked safety concerns for first responders, which in turn, has sparked the onset of various new regulations requiring increasingly more safety features. In particular, concerns have been raised about the safety of firemen moving around and coming into contact solar panels that are actively generating electricity, especially solar panels that may have been damaged by the very event that caused the summoning of firemen (e.g., a fire involving a structure or location at which a sizable array of solar panels may be present). Among such safety regulations that have started to take hold are requirements for each solar panel to be equipped with an electronic device that allows the output of electricity generated by each single solar panel to occur only so long as a particular RF signal continues to be transmitted to and received by each such electronic device at each solar panel, and corresponding requirements that an easily locatable and accessible shut-off switch be provided that can be used by such first responders to cause the cessation of transmission of such an RF signal. With the cessation of transmission of such an RF signal, each such electronic device cuts off the electrical output of its associated solar panel, thereby causing each solar panel of an array of solar panels to become electrically isolated.

However, a backlash has developed among installers and users of solar panels against such requirements due to concerns over increased service calls that may be required to address instances of such devices that may fail long before the end of the useful life of a typical solar panel (e.g., 25 or 30 years). The use of the metallic material or at least thermally conductive material of the shield 200 as a heatsink may easily increase the likely lifespan of such electronic devices, thereby alleviating this issue.

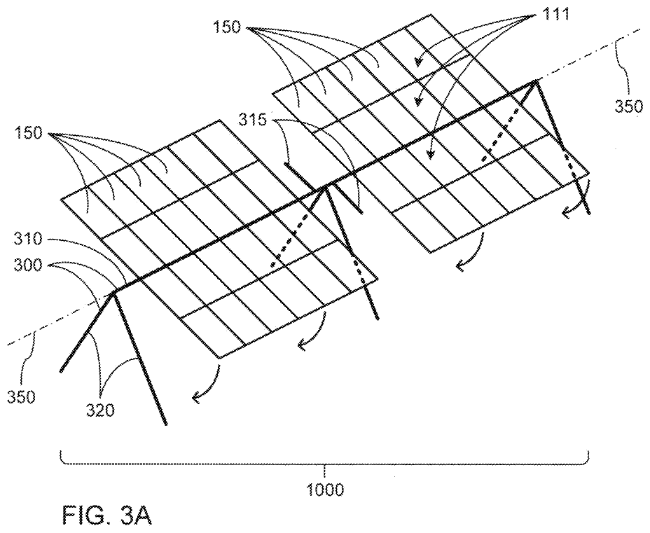

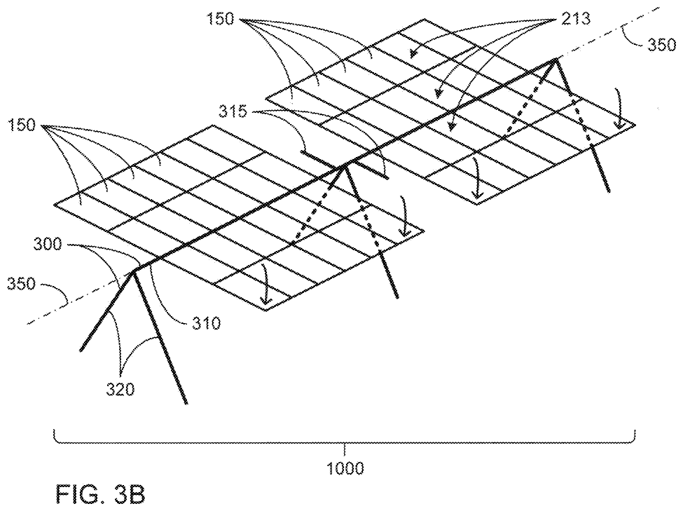

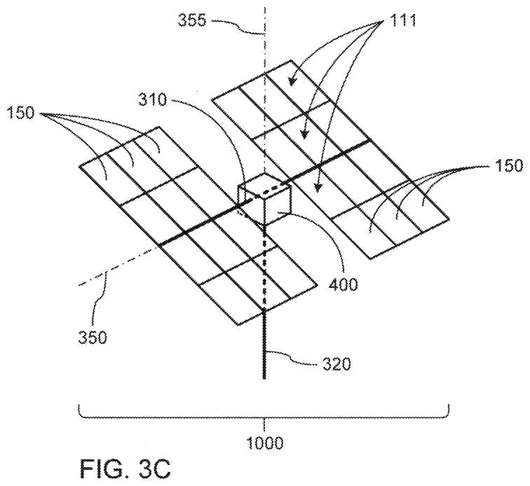

FIGS. 3A through 3C, taken together, provide perspective views of examples of the support frame 300 to support multiple panel assemblies 150 in rotatable manner above a support surface (e.g., the support surface 1001 depicted in FIG. 1A). As is depicted, and as is about to be discussed, widely differing configurations of support components may be used in creating a wide variety of examples of the support frame 300. However, as depicted, the examples of the support frame 300 depicted in both FIGS. 3A-B and in FIG. 3C may be configured to support panel assemblies 150 in which solar panels 100 and shields 200 may be assembled back-to-back and in parallel as earlier depicted in FIGS. 1A and 2.

FIGS. 3A-B provide perspective views of one example support frame 300 employing multiple support components 320 used in pairs to form vertical A-frame portions to rotatably support a horizontal component 310 in a manner enabling its rotation about the depicted axis 350. As depicted, numerous panel assemblies 150 may be attached to the horizontal component 310, thereby enabling the rotation of those numerous panel assemblies 150 together with the horizontal component 310 about the axis 350.

More specifically, FIG. 3A depicts the panel assemblies 150 as having been rotated into a collection orientation in which the panel assemblies 150 are positioned to cause the collection surface 111 of the solar panels 100 to face upward to collect direct sunlight from the sun. In contrast, FIG. 3B depicts the panel assemblies 150 as having been rotated into a protective orientation in which the protective surface 213 of the shield to face upward, thereby causing the shields 200 be positioned above the solar panels 100 so that each shield 200 is able protect its corresponding solar panel 100 from impacts by falling objects (e.g., hailstones of inclement weather, etc.) and other objects that may have been carried aloft by winds associated with inclement weather.

Also depicted in both FIGS. 3A and 3B are at least a pair of crank arms 315 by which cables, ropes, chains, connecting rods, etc. may be used under the control of one or more of the actuator assemblies 400 to effect the rotation of the horizontal component 310 together with the numerous panel assemblies 150 between the collection orientation of FIG. 3A and the protective orientation of FIG. 3B. More specifically, as depicted in FIGS. 3A and 3B, each of the depicted crank arms 315 may extend radially outward from the axis 350 and the horizontal component 310 within the same plane as do the panel assemblies 150 extend from the axis 350 and the horizontal component 310. However, it should be noted that one or more of the depicted crank arms 315 may alternately extend radially outward from the axis 350 and the horizontal component 350 in directions that are not with such planes. As will be discussed in greater detail, such one or more actuator assemblies 400 may be mounted to the same support surface to which the support frame 300 may be mounted. As will be appreciated by those skilled in the art, the exact direction that each crank arm 315 may extend radially outwardly from the axis 350 and the horizontal component 310 may be dictated by what radially outward direction for each crank arm 315 best enables each actuator assembly 400 to push and/or pull on a crank arm 315 to rotate the horizontal component 310 together with the panel assemblies 150 toward a desired orientation to either protect the solar panels 100 or to expose the solar panels 100 to direct sunlight.

Although the example support frame 300 may include more or fewer of the A-frame portions than the three A-frame portions that are depicted in FIGS. 3A-B, it is envisioned that the example support frame 300 of FIGS. 3A-B would be deemed advantageous for use in creating a sizable solar array of a type that may be used on an industrial scale to provide electric power to an industrial facility and/or on a utility scale to provide electric power to multiple structures of any of a variety of types.

FIG. 3C provides a perspective view of different example support frame 300 employing a single vertically extending support component 320 to rotatably support a horizontal component 310 in a manner enabling its rotation about either or both of the axis 350 and another axis 355. As depicted, a set of panel assemblies 150 may be attached to the horizontal component 310, which in turn, may be supported by components of a pair of actuator assemblies 400 carried atop the single support component 320, thereby enabling the rotation of that set of panel assemblies 150 together with the horizontal component 310 about either or both of the axes 350 and 355.

In a manner somewhat similar to FIG. 3A, FIG. 3C depicts the panel assemblies 150 as having been rotated into a collection orientation in which the panel assemblies 150 are positioned to cause the collection surface 111 of the solar panels 100 to face upward to collect direct sunlight from the sun.

Although the example support frame 300 may include more or fewer of the panel assemblies 150 than are depicted in FIG. 3C, it is envisioned that the example support frame 300 of FIG. 3C would be deemed advantageous for use in creating a relatively small solar array of a type that may be used on a small scale to provide electric power to just one or two structures on a single residential or small business property.

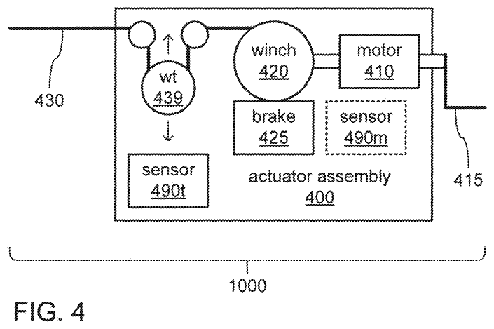

FIG. 4 provides a block diagram depicting various aspects of an example actuator assembly 400 of a type that selectively pays out and retracts a cable 430 as part of repositioning panel assemblies 150 carried on a mounting frame 300. As depicted, this example actuator assembly may include a motor 410, a hand crank 415, a winch 420 around which at least a portion of the cable 430 may be wound, a brake 425, a weight 439 that may be suspended at a varying height from the cable 430, and/or one or more of the sensors 490.

It is envisioned that the motor 410 may be an electric motor. However, the motor 410 may alternatively be any of a variety of types of motor that may use any of a variety of sources of energy. By way of example, where a supply of gasoline, diesel, oil, methane, hydrogen or other combustible fuel is available, it may be that the motor 410 is an internal combustion engine using pistons, a gas turbine engine, etc. Also by way of example, it may be that the motor 410 is of a type that is driven by compressed air, hydraulic fluid, etc. Additionally, in situations in which the motor 410 fails and/or where a source of energy needed to operate the motor 410 fails, the hand crank 415 may be manually operated to cause the winch 420 to either pay out or retract the cable 430 in lieu of using the motor 410 to do so.

The winch 420 may be based any of a variety of types of spool able to connected to an armature of the motor 410, either directly, or through any of a variety of types mechanical mechanism able to convey rotational motion from the motor 410 to the winch 420. The winch 420 may be accompanied by the brake 425 that is operable to stop the winch 420 from rotating at least at times when the winch 420 is not being driven to rotate by the motor 410.

The brake 425, if present, may any of a variety of types of brake, including and not limited to, a disc brake, a drum brake, a caliper brake, etc. It is envisioned that the brake 425 may be configured to, by default, act to stop the winch 420 from rotating. Stated differently, it may be that the brake 425 requires energy to be provided to the brake 425 to cause it to release the winch 420 such that the winch 420 is able to rotate, instead of requiring energy to be provided to the brake 425 to cause it to stop the winch 420 from rotating. This may be deemed to be desirable failsafe state for the winch 420 and the brake 425 such that holding the winch 420 motionless is the default behavior when no energy to operate components of the actuator assembly 400 is available.

As depicted, the weight 439 may be suspended by a portion of the cable 430 that loops down from a pair of pulleys such that the weight 439 is lifted to varying heights depending on the amount of tension in the cable 430. This interaction between the cable 430 and the weight 439 may be used, together with the depicted tension sensor 490t, to measure the current tension in the cable 430. As tension in the cable 430 increases or decreases, the weight 439 is lifted higher or lower, respectively, and the tension sensor 490t may detect the current height of the weight 439 as part of measuring the current tension in the cable 430.

In addition to or in lieu of the inclusion of the tension sensor 490t, the motor 410 may be accompanied by and/or otherwise incorporate the depicted motor sensor 490m. The motor sensor 490m may be any of a variety of types of sensor that may employ optics, magnetic fields, changes in current flow and/or voltage, etc. to detect the current rotary position, rotational speed and/or torque of the armature of the motor 410. Such information may be used to determine a degree of tension in the cable 430 and/or the rate at which the cable 430 is being payed out or retracted.

As an alternative, other sensors such as load cells (not specifically shown) may be used to measure the pulling force exerted on the winch 420 by the cable 430 as an approach to measuring tension in the cable 430. As another alternative, other sensors such as load cells incorporated into the mounts of the motor 410 and/or into the armature of the motor 410 may be used to detect the rotational force exerted by the cable 430 on the motor 410 through the winch 420 as another approach to measuring tension in the cable 430.

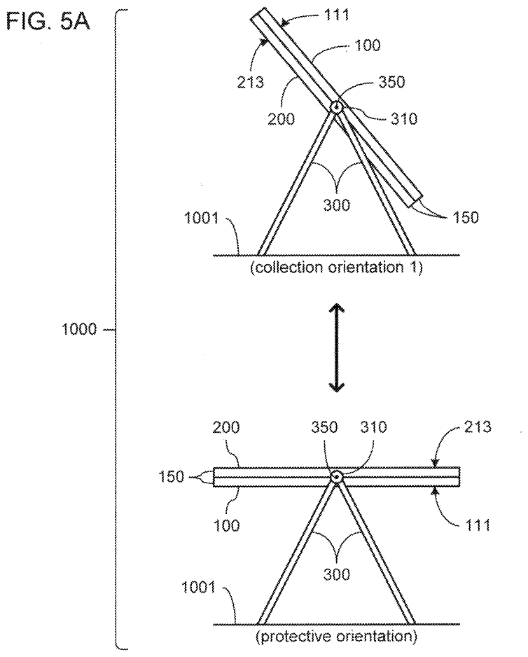

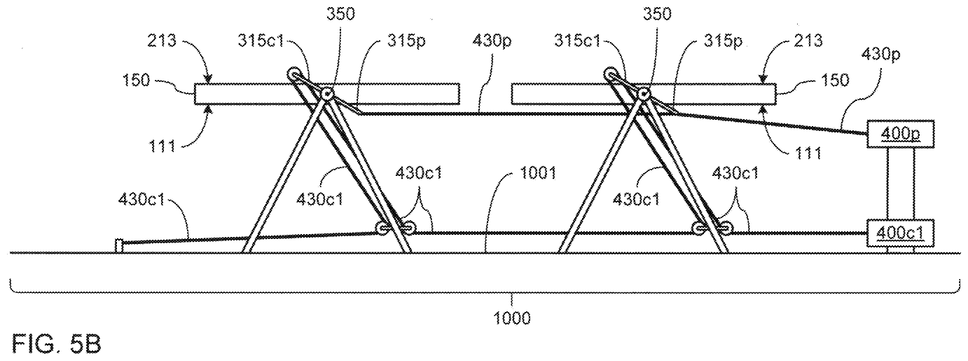

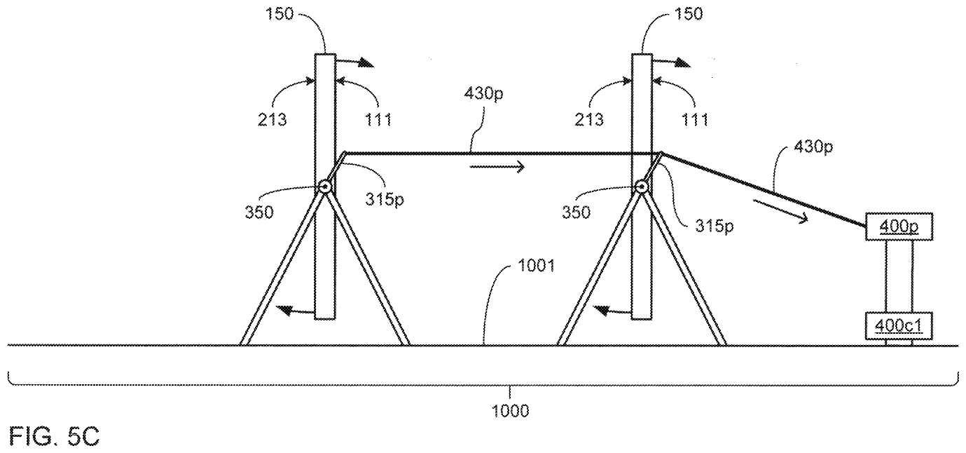

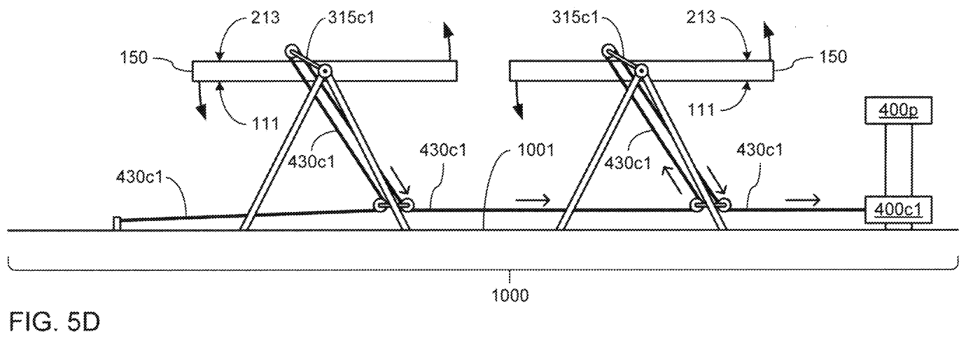

FIGS. 5A through 5D, taken together, provide elevational views of one example of the solar panel positioning system 1000 employing a pair of actuator assemblies 400p and 400c1 to reposition multiple panel assemblies 150 in one of a protective orientation and a single collection orientation in response to inclement weather. The mounting frame(s) 300 of this example system 1000 may be similar to the example mounting frame 300 of FIGS. 3A-B. Also, the actuator assemblies 400p and/or 400c1 of this example system 1000 may be similar to the example actuator assembly 400 of FIG. 4.

FIG. 5A provides an elevational view of the protective orientation and the single collection orientation (designated as “collection orientation 1”). FIGS. 5B-D provide elevational views of the manner in which each of the actuator assemblies 400p and 400c 1 may be used primarily to, at different times, retract respective ones of cables 430pa and 430c1 to pull respective ones of the depicted crank arms 315p and 315c1 to cause rotation of the horizontal component 310 of each of one or more mounting frames 310, together with corresponding panel assemblies 150, toward respective ones of the protective orientation and the single collection orientation.

Continuing with FIGS. 5B-D, the crank arm 315p of each of the depicted mounting frames 300 may extend radially outwardly from its corresponding axis 350 and horizontal component 310 in a direction that is selected to cause the actuator assembly 400p to become specialized for use in rotating the panel assemblies 150 together with the horizontal component 310 of each of the corresponding mounting frames 300 into the protective orientation depicted in FIG. 5A, which may be similar to the protective orientation depicted in FIG. 3B. As depicted, the cable 430p may be directly connected to each such crank arm 315p in a “daisy-chain” manner such that the tension exerted on the cable 430p directly pulls on each such crank arm 315p simultaneously. Also, as the actuator assembly 400p is operated by the control device 500 to retract its cable 430p to exert a pulling force on the crank arm 315p to cause such a rotation, the actuator assembly 400c1 may be relied upon to pay out its cable 430c1 in a controlled manner that provides limited, but sufficient, slack in the cable 430c1 to not impede such rotation to the protective orientation.

Correspondingly, the crank arm 315c1 of each of the depicted mounting frames 300 may extend radially outwardly from its corresponding axis 350 and horizontal component 310 in a direction that is selected to cause the actuator assembly 400c1 to become specialized for use in rotating the panel assemblies 150 together with the horizontal component 310 of each of the corresponding mounting frames 300 into the single collection orientation depicted in FIG. 5A, which may be similar to the collection orientation depicted in FIG. 3A. As depicted, the cable 430c1 may be indirectly connected to each such crank arm 315c1 via a pulley, but also in a “daisy-chain” manner such that the tension exerted on the cable 430c1 pulls on each such crank arm 315c1. Such an indirect coupling may allow some degree of variance between the rate of rotation of the panel assemblies 150 of one mounting frame 300 and the rate of rotation of the panel assemblies 150 of the other mounting frame 300. Also, as the actuator assembly 400c1 is operated by the control device 500 to retract its cable 430c1 to exert a pulling force on the crank arm 315c1 to cause such a rotation, the actuator assembly 400p may be relied upon to pay out its cable 430p in a controlled manner that provides limited, but sufficient, slack in the cable 430p to not impede such rotation to the single collection orientation.

In some variants, where one of the actuator assemblies 400p or 400c1 is relied upon to pay out its cable 430p or 430c1, respectively, in a controlled manner as discussed in reference to FIG. 4, such controlled paying out may be accomplished through use of the brake 425 to impose a preselected amount of friction on the cable 430p or 430c1 that is being payed out. In this way, a controlled amount of resistance to being payed out may be used to provide a controlled amount of tension on the cable 430p or 430c1 that is being payed out to at least avoid too high a rate of paying out such that excess slack develops in the cable 430p or 430c1 that is being payed out, which may allow that cable 430p or 430c1 to become entangled with other components of the solar panel positioning system 1000.

In other variants, where one of the actuator assemblies 400p or 400c1 is relied upon to pay out its cable 430p or 430c1, respectively, in a controlled manner as discussed in reference to FIG. 4, the control device 500 may operate the motor 410 in that one of the actuator assemblies 400p or 400c1 to actively pay out that cable. In so doing, the control device 500 may operate one or more sensors 490 within that one of the actuator assemblies 400p or 400c1 to monitor the level of tension on the cable 430p or 430c1, respectively, that is being payed out to maintain the tension either at a preselected level of tension or within a preselected range of levels of tension to, again, avoid allowing too much slack to develop.

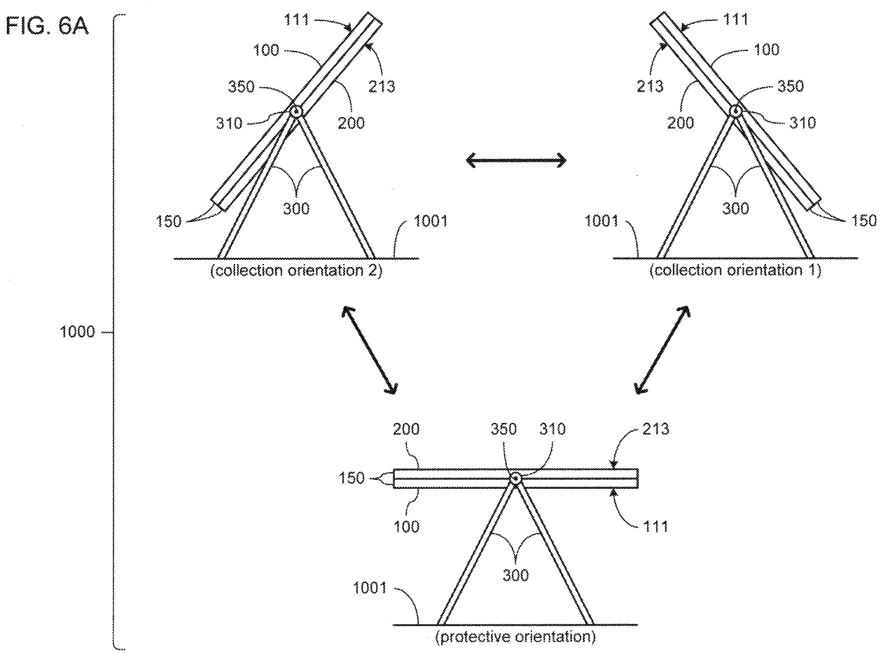

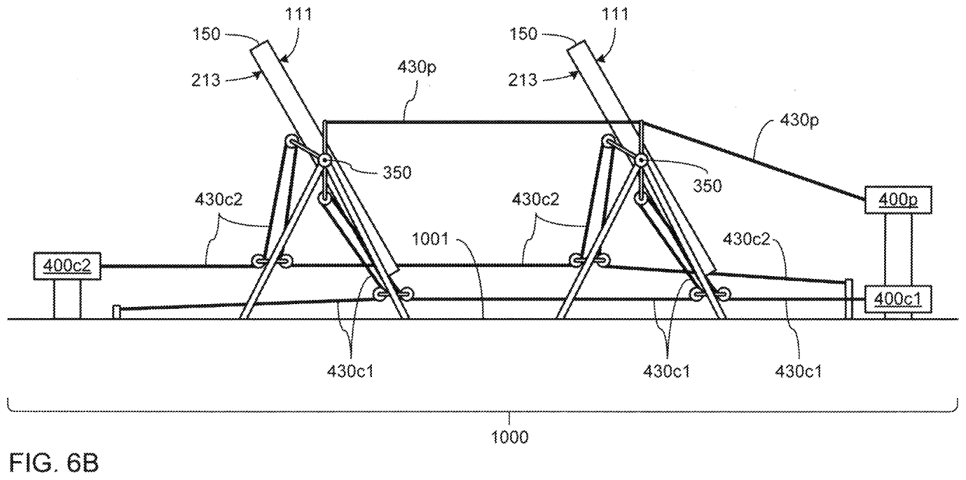

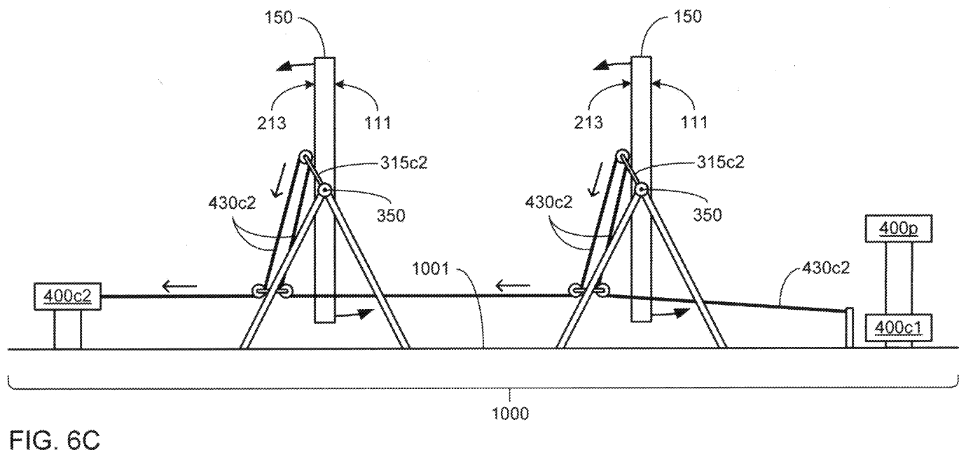

FIGS. 6A through 6C, taken together, provide elevational views of another example of the solar panel positioning system 1000 employing a triplet of actuator assemblies 400p, 400c1 and 400c2 to reposition multiple panel assemblies 150 in one of a protective orientation and two collection orientations in response to inclement weather. Similar to the mounting frame(s) 300 of FIGS. 5A-D, the mounting frame(s) 300 of this other example system 1000 may be similar to the example mounting frame 300 of FIGS. 3A-B. Also, similar to the actuator assemblies 400p and/or 400c1 of FIGS. 5A-D, the actuator assemblies 400p, 400c1 and/or 400c2 of this other example system 1000 may be similar to the example actuator assembly 400 of FIG. 4. Indeed, it may be that this other example solar panel positioning system 1000 of FIGS. 6A-C is a superset, in components and/or in functionality, to the example solar positioning system 1000 of FIGS. 5A-D.

FIG. 6A provides an elevational view of the protective orientation and the two collection orientations (designated as “collection orientation 1″ and ”collection orientation 2″). FIGS. 6B-C, along with FIGS. 5C-D, provide elevational views of the manner in which each of the actuator assemblies 400p, 400c1 and 400c2 may be used primarily to, at different times, retract respective ones of cables 430pa, 430 c1 and 430 c2 to pull respective ones of the depicted crank arms 315p, 315c1 and 315c2 to cause rotation of the horizontal component 310 of each of one or more mounting frames 310, together with corresponding panel assemblies 150, toward respective ones of the protective orientation and the two collection orientations.

Having multiple collection orientations may be part of an approach to improving the performance of the collection of sunlight and generation of electricity therefrom by having the solar panels 100 more closely follow the path of the sun across the sky from dusk to dawn each day. As will be recognizable to those skilled in the art, the two particular collection orientations depicted in FIG. 6A are consistent with such an approach. Alternatively or additionally, having multiple collection orientations may be part of an approach to improving the performance of the collection of sunlight and generation of electricity therefrom by the solar panels 100 by having the solar panels 100 better angled toward the elevation of the sun in the sky as the seasons change during each year.

Again, it may be that this other example solar panel positioning system 1000 of FIGS. 6A-C is a superset, in components and/or in functionality, to the example solar positioning system 1000 of FIGS. 5A-D. For this reason, FIGS. 5C-D may be relied upon to depict the structural and functional details of the actuator assemblies 400p and 400c1, the cable 430p and 430c1, and the crank arms 315p and 315c1, respectively, of this other example solar positioning system 1000 of FIGS. 6A-C. In effect, this other example solar positioning system 1000 of FIGS. 6A-C may be regarded as essentially the example solar positioning system 1000 of FIGS. 5A-D, but with the actuator assembly 400c2, the cable 430c2, the crank arm 315c2, and the functionality associated with the other collection orientation designated “collection orientation 2” added.

As part of being such a superset, the interplay in the retracting and paying out cables among the three actuator assemblies 400p, 400c1 and 400c2 of FIGS. 6A-C may closely resemble the earlier described interplay in the retracting and paying out of cables among the two actuator assemblies 400p and 400c1 of FIGS. 5A-D. More specifically, while any single one of the three actuator assemblies 400p, 400c1 or 400c2 of FIGS. 6A-C is retracting its corresponding one of the cables 430p, 430c1 or 430c2, the other two of these three actuator assemblies may be relied upon to pay out their respective ones of the cables 430p, 430c1 and 430c2 in a controlled manner. As was discussed in reference to FIGS. 5A-D, as well as in reference to FIG. 4, such controlled paying out may be effected using the brake 425 or using the motor 410 in combination with one or more sensors 490.

Referring back to FIGS. 5A-D and 6A-C, it should be noted that, unlike the depiction of crank arms 315 in the mounting frame 300 depicted in FIGS. 3A-B, the crank arms 315p, 315c1 and 315c2 depicted throughout FIGS. 5B-D and 6B-C are not depicted as extending radially outward from the axes 350 and horizontal components 310 within the planes of the panel assemblies 150. This is done throughout FIGS. 5B-D and 6B-C to improve the visibility of various features in these figures to thereby improve ease of understanding. It may be that, in actual implementations, the crank arms 315p, 315c1 and/or 315c2 are at least more likely to be positioned to extend in the plane of the panel assemblies 150 depicted in FIGS. 5B-D and/or FIGS. 6B-C. Additionally, it should be noted that the various pulleys depicted in FIGS. 5B-D and 6B-C have been depicted in a relatively widely separated manner that is deliberately chosen to enable the paths taken by the cables 430p, 430c1 and 430c2 to be depicted with minimal overlap to be more easily viewed. It may be that, in actual implementations, sets of adjacent ones of the pulleys are assembled together into sets of pulleys that each share a common shaft within that set.

There is thus disclosed a system for protecting solar panels from inclement weather by rotating them between a collecting position for collecting solar energy and a protective orientation in which sheets of protective material are positioned above the solar panels to absorb and/or deflect impacts from hailstones and/or other falling objects associated with inclement weather.

A solar panel positioning system includes at least one processor configured to perform operations including receive indications of inclement weather, and in response to at least one indication of inclement weather, perform further operations including: operate at least one actuator assembly to rotate at least one panel assembly comprising a solar panel and shield from at least one collection orientation that enables the solar panel to receive direct sunlight, and to a protective orientation that positions the shield above the solar panel to enable the shield to protect the solar panel from a falling object associated with the inclement weather; and maintain the at least one panel assembly in the protective orientation for at least a predetermined period of time before allowing the at least one panel assembly to be rotated out of the protective orientation.

The solar panel positioning system may further include a local weatherstation at a location of the at least one panel assembly, wherein: the local weather station is configured to detect or measure at least one aspect of weather conditions at the location of the at least one panel assembly, and to transmit weather data indicative of the weather conditions at the location of the at least one panel assembly to the at least one processor; and the weather data comprises the at least one indication of inclement weather.

The local weatherstation may include a radar configured to detect at least one of the inclement weather and the falling object, and to transmit data indicative of the detection of at least one of the inclement weather and the falling object to the at least one processor; and the at least one processor may be further configured to analyze the data to identify the detection of at least one of the inclement weather and the falling object as the at least one indication of inclement weather.

Each panel assembly of the at least one panel assembly may include at least one sensor configured to detect a physical strike of the falling object on the solar panel, and to transmit an indication of the physical strike to the at least one processor; and the at least one indication of inclement weather received by the at least one processor may include the indication of the physical strike.

Each panel assembly of the at least one panel assembly may include at least one sensor configured to detect a physical strike of the falling object on the shield, and to transmit an indication of the physical strike to the at least one processor, and the at least one processor may be further configured to perform operations including: receive the indication of the physical strike, and in response to the indication of the physical strike, maintain the at least one panel assembly in the protective orientation for an additional period of time before allowing the at least one panel assembly to be rotated out of the protective orientation.

The at least one processor may be further configured to perform further operations including: receive weather data from a data source located remotely from a location of the at least one panel assembly, wherein the weather data may be indicative of current weather conditions or predicted weather conditions at the location of the at least one panel assembly; and analyze the weather data to determine whether the weather data comprises the at least one indication of inclement weather, wherein the weather data may include at least one of: a text description of at least one aspect of the weather conditions or predicted weather conditions at the location of the at least one panel assembly, and the at least one processor is further configured to parse the text to determine whether the weather data comprises the at least one indication of inclement weather; and a radar image indicative of the current weather conditions at the location of the at least one panel assembly, and the at least one processor is further configured to use image analysis of the radar image to determine whether the weather data comprises the at least one indication of inclement weather.

The solar panel positioning system may further include a mounting frame, wherein: the mounting frame may include a horizontal component rotatably supported by at least one other component of the mounting frame above a support surface that is exposed to sunlight; and the at least one panel assembly may be attached to the horizontal component for rotation with the horizontal component about an axis between the at least one collection orientation and the protective orientation.

The at least one collection orientation may include multiple collection orientations to improve collection of direct sunlight through at least one of dawn to dusk of each day, and changes in elevation of the sun through multiple seasons of each year. The at least one actuator assembly may include at least: a first actuator assembly to retract a first cable coupled to horizontal component to rotate the horizontal component together with the at least one panel assembly to a first collection orientation; a second actuator assembly to retract a second cable coupled to horizontal component to rotate the horizontal component together with the at least one panel assembly to a second collection orientation; and a third actuator assembly to retract a third cable coupled to horizontal component to rotate the horizontal component together with the at least one panel assembly to the protective orientation. Operating the at least one actuator assembly to rotate the at least one panel assembly from at least one collection orientation, and to the protective orientation may include operating the third actuator while simultaneously operating at least one of the first actuator and the second actuator to pay out an amount of at least one of the first cable and the second cable.

A method includes receiving, by at least one processor of a solar panel positioning system, indications of inclement weather, and in response to at least one indication of inclement weather, performing further operations including: operating at least one actuator assembly to rotate at least one panel assembly comprising a solar panel and shield about a horizontal axis from at least one collection orientation that enables the solar panel to receive direct sunlight, and to a protective orientation that positions the shield above the solar panel to enable the shield to protect the solar panel from a falling object associated with the inclement weather; and maintaining the at least one panel assembly in the protective orientation for at least a predetermined period of time before allowing the at least one panel assembly to be rotated out of the protective orientation.

Each panel assembly of the at least one panel assembly may include at least one sensor, and the method may further include: operating the at least one sensor to detect a physical strike of the falling object on the solar panel; transmitting, from the at least one sensor, and to the at least one processor, an indication of the physical strike; and receiving, by the at least one processor, the indication of the physical strike as the at least one indication of inclement weather.

Each panel assembly of the at least one panel assembly may include at least one sensor. The method may further include: operating the at least one sensor to detect a physical strike of the falling object on the shield; transmitting, from the at least one sensor, and to the at least one processor, an indication of the physical strike; and receiving, by the at least one processor, the indication of the physical strike, and in response to the indication of the physical strike, maintaining the at least one panel assembly in the protective orientation for an additional period of time before allowing the at least one panel assembly to be rotated out of the protective orientation. Operating the at least one actuator assembly to rotate the at least one panel assembly from at least one collection orientation, and to the protective orientation may include operating the third actuator while simultaneously operating at least one of the first actuator and the second actuator to pay out an amount of at least one of the first cable and the second cable.

The at least one collection orientation may include multiple collection orientations to improve collection of direct sunlight through at least one of dawn to dusk of each day, and changes in elevation of the sun through multiple seasons of each year. The at least one actuator assembly may include at least: a horizontal component to which the at least one panel assembly is coupled for being rotated above a support surface that is exposed to sunlight; a first actuator assembly to retract a first cable coupled to the horizontal component to rotate the horizontal component together with the at least one panel assembly to a first collection orientation; a second actuator assembly to retract a second cable coupled to the horizontal component to rotate the horizontal component together with the at least one panel assembly to a second collection orientation; and a third actuator assembly to retract a third cable coupled to the horizontal component to rotate the horizontal component together with the at least one panel assembly to the protective orientation. Operating the at least one actuator assembly to rotate the at least one panel assembly from at least one collection orientation, and to the protective orientation may include operating the third actuator while simultaneously operating at least one of the first actuator and the second actuator to pay out an amount of at least one of the first cable and the second cable.

The method may further include: operating, by the at least one processor, a sensor at a location of the at least one panel assembly to detect a build up of at least one of ice, sleet and snow on a collection surface of at least one solar panel of the at least one panel assembly; and in response to detection of the build up of at least one of ice, sleet and snow on the collection surface of the at least one solar panel, operating the least one actuator assembly to rotate the least one panel assembly from the at least one collection orientation, and to a protective orientation, to cause the at least one collection surface to face downward toward a support surface above which the at least one panel assembly is supported to enable the at least one of ice, sleet and snow to fall away from the at least one collection surface.

A solar panel positioning system including: at least one panel assembly including a solar panel and a shield, wherein the solar panel is of a generally elongate rectangular shape defining a collection surface to receive direct sunlight from which to generate electricity, the shield comprises a sheet of material also of a generally elongate rectangular shape and the shield extends in parallel to a back surface of the solar panel that is opposite to the collection surface; and a mounting frame comprising a horizontal component to which the at least one panel assembly is coupled for being supported above a support surface that is exposed to the sunlight, wherein the horizontal component is configured to be rotated together with the at least one panel assembly from at least one collection orientation that enables the solar panel to receive direct sunlight, and to a protective orientation that positions the shield above the solar panel to enable the shield to protect the solar panel from a falling object associated with the inclement weather.

The at least one collection orientation may include multiple collection orientations to improve collection of direct sunlight through at least one of dawn to dusk of each day, and changes in elevation of the sun through multiple seasons of each year. The solar panel positioning system may further include: a first actuator assembly to retract a first cable coupled to the horizontal component to rotate the horizontal component together with the at least one panel assembly to a first collection orientation; a second actuator assembly to retract a second cable coupled to the horizontal component to rotate the horizontal component together with the at least one panel assembly to a second collection orientation; and a third actuator assembly to retract a third cable coupled to the horizontal component to rotate the horizontal component together with the at least one panel assembly to the protective orientation. Rotating the at least one panel assembly from at least one collection orientation, and to the protective orientation may include operating the third actuator assembly to retract the third cable while simultaneously operating at least one of the first actuator assembly and the second actuator assembly to pay out an amount of at least one of the first cable and the second cable.

Operating the first actuator assembly to pay out an amount of the first cable may include operating a first brake of the first actuator assembly to impose a first preselected amount of resistance on the paying out of the first cable; and operating the second actuator assembly to pay out an amount of the second cable may include operating a second brake of the second actuator assembly to impose a second preselected amount of resistance on the paying out of the second cable.

Operating the first actuator assembly to pay out an amount of the first cable may include operating a first motor of the first actuator assembly to actively pay out the first cable at a rate that imposes a preselected amount of tension on the first cable; and operating the second actuator assembly to pay out an amount of the second cable may include operating a second motor of the second actuator assembly to actively pay out the second cable at a rate that imposes a preselected amount of tension on the second cable.

Each panel assembly of the at least one panel assembly may include at least one sensor configured to detect a physical strike of the falling object on the solar panel, and to transmit an indication of the physical strike to at least one processor of the solar panel positioning system; and the at least one processor may be configured to operate at least one actuator assembly to rotate the horizontal component together with the at least one panel assembly from the at least one collection orientation and to the protective orientation in response to the indication of the physical strike.

Each panel assembly of the at least one panel assembly may include at least one sensor configured to detect a physical strike of the falling object on the shield, and to transmit an indication of the physical strike to at least one processor of the solar panel positioning system; and the at least one processor may be configured to operate to delay operating at least one actuator assembly to rotate the horizontal component together with the at least one panel assembly back to the at least one collection orientation from the protective orientation in response to the indication of the physical strike.

The shield of the at least one panel assembly may include a sheet of metallic material or other thermally conductive material; the at least one panel assembly may further include an electronic device that electrically coupled to the solar panel, and is physically coupled to the shield to use the shield as a heatsink; and the electronic device may include at least one of a DC to AC inverter, and a bypass device that enables a flow of electric current from at least one other solar panel to bypass the solar panel.

We claim:

1. A solar panel positioning system comprising at least one processor configured to perform operations comprising:
receive indications of inclement weather; and
in response to at least one indication of inclement weather, perform further operations comprising:
operate at least one actuator assembly to rotate at least one panel assembly comprising a solar panel and shield from at least one collection orientation that enables the solar panel to receive direct sunlight, and to a protective orientation that positions the shield above the solar panel to enable the shield to protect the solar panel from a falling object associated with the inclement weather; and
maintain the at least one panel assembly in the protective orientation for at least a predetermined period of time before allowing the at least one panel assembly to be rotated out of the protective orientation.

2. The solar panel positioning system of claim 1, further comprising a local weatherstation at a location of the at least one panel assembly, wherein:
the local weather station is configured to detect or measure at least one aspect of weather conditions at the location of the at least one panel assembly, and to transmit weather data indicative of the weather conditions at the location of the at least one panel assembly to the at least one processor; and
the weather data comprises the at least one indication of inclement weather.

3. The solar panel positioning system of claim 2, wherein:
the local weatherstation comprises a radar configured to detect at least one of the inclement weather and the falling object, and to transmit data indicative of the detection of at least one of the inclement weather and the falling object to the at least one processor; and
the at least one processor is further configured to analyze the data to identify the detection of at least one of the inclement weather and the falling object as the at least one indication of inclement weather.

4. The solar panel positioning system of claim 1, wherein:
each panel assembly of the at least one panel assembly comprises at least one sensor configured to detect a physical strike of the falling object on the solar panel, and to transmit an indication of the physical strike to the at least one processor; and
the at least one indication of inclement weather received by the at least one processor comprises the indication of the physical strike.

5. The solar panel positioning system of claim 1, wherein:
each panel assembly of the at least one panel assembly comprises at least one sensor configured to detect a physical strike of the falling object on the shield, and to transmit an indication of the physical strike to the at least one processor; and
the at least one processor is further configured to perform operations comprising:
receive the indication of the physical strike, and
in response to the indication of the physical strike, maintain the at least one panel assembly in the protective orientation for an additional period of time before allowing the at least one panel assembly to be rotated out of the protective orientation.

6. The solar panel positioning system of claim 1, wherein the at least one processor is further configured to perform further operations comprising:
receive weather data from a data source located remotely from a location of the at least one panel assembly, wherein the weather data is indicative of current weather conditions or predicted weather conditions at the location of the at least one panel assembly; and
analyze the weather data to determine whether the weather data comprises the at least one indication of inclement weather, wherein the weather data comprises at least one of:
a text description of at least one aspect of the weather conditions or predicted weather conditions at the location of the at least one panel assembly, and the at least one processor is further configured to parse the text to determine whether the weather data comprises the at least one indication of inclement weather; and
a radar image indicative of the current weather conditions at the location of the at least one panel assembly, and the at least one processor is further configured to use image analysis of the radar image to determine whether the weather data comprises the at least one indication of inclement weather.

7. The solar panel positioning system of claim 1, further comprising a mounting frame, wherein:
the mounting frame comprises a horizontal component rotatably supported by at least one other component of the mounting frame above a support surface that is exposed to sunlight; and
the at least one panel assembly is attached to the horizontal component for rotation with the horizontal component about an axis between the at least one collection orientation and the protective orientation.

8. The solar panel positioning system of claim 7, wherein:
the at least one collection orientation comprises multiple collection orientations to improve collection of direct sunlight through at least one of dawn to dusk of each day, and changes in elevation of the sun through multiple seasons of each year;
the at least one actuator assembly comprises at least:
a first actuator assembly to retract a first cable coupled to horizontal component to rotate the horizontal component together with the at least one panel assembly to a first collection orientation;
a second actuator assembly to retract a second cable coupled to horizontal component to rotate the horizontal component together with the at least one panel assembly to a second collection orientation; and
a third actuator assembly to retract a third cable coupled to horizontal component to rotate the horizontal component together with the at least one panel assembly to the protective orientation; and
operating the at least one actuator assembly to rotate the at least one panel assembly from at least one collection orientation, and to the protective orientation comprises operating the third actuator while simultaneously operating at least one of the first actuator and the second actuator to pay out an amount of at least one of the first cable and the second cable.

9. A method comprising:
receiving, by at least one processor of a solar panel positioning system, indications of inclement weather; and
in response to at least one indication of inclement weather, performing further operations comprising:
operating at least one actuator assembly to rotate at least one panel assembly comprising a solar panel and shield about a horizontal axis from at least one collection orientation that enables the solar panel to receive direct sunlight, and to a protective orientation that positions the shield above the solar panel to enable the shield to protect the solar panel from a falling object associated with the inclement weather; and
maintaining the at least one panel assembly in the protective orientation for at least a predetermined period of time before allowing the at least one panel assembly to be rotated out of the protective orientation.

10. The method of claim 9, wherein:
each panel assembly of the at least one panel assembly comprises at least one sensor; and
the method further comprises:
operating the at least one sensor to detect a physical strike of the falling object on the solar panel;
transmitting, from the at least one sensor, and to the at least one processor, an indication of the physical strike; and
receiving, by the at least one processor, the indication of the physical strike as the at least one indication of inclement weather.

11. The method of claim 9, wherein:
each panel assembly of the at least one panel assembly comprises at least one sensor;
the method further comprises:
operating the at least one sensor to detect a physical strike of the falling object on the shield;
transmitting, from the at least one sensor, and to the at least one processor, an indication of the physical strike; and
receiving, by the at least one processor, the indication of the physical strike, and
in response to the indication of the physical strike, maintaining the at least one panel assembly in the protective orientation for an additional period of time before allowing the at least one panel assembly to be rotated out of the protective orientation; and
operating the at least one actuator assembly to rotate the at least one panel assembly from at least one collection orientation, and to the protective orientation comprises operating the third actuator while simultaneously operating at least one of the first actuator and the second actuator to pay out an amount of at least one of the first cable and the second cable.

12. The method of claim 9, wherein:
the at least one collection orientation comprises multiple collection orientations to improve collection of direct sunlight through at least one of dawn to dusk of each day, and changes in elevation of the sun through multiple seasons of each year;
the at least one actuator assembly comprises at least:
a horizontal component to which the at least one panel assembly is coupled for being rotated above a support surface that is exposed to sunlight;
a first actuator assembly to retract a first cable coupled to the horizontal component to rotate the horizontal component together with the at least one panel assembly to a first collection orientation;
a second actuator assembly to retract a second cable coupled to the horizontal component to rotate the horizontal component together with the at least one panel assembly to a second collection orientation; and
a third actuator assembly to retract a third cable coupled to the horizontal component to rotate the horizontal component together with the at least one panel assembly to the protective orientation; and
operating the at least one actuator assembly to rotate the at least one panel assembly from at least one collection orientation, and to the protective orientation comprises operating the third actuator while simultaneously operating at least one of the first actuator and the second actuator to pay out an amount of at least one of the first cable and the second cable.

13. The method of claim 9, further comprising:
operating, by the at least one processor, a sensor at a location of the at least one panel assembly to detect a build up of at least one of ice, sleet and snow on a collection surface of at least one solar panel of the at least one panel assembly; and
in response to detection of the build up of at least one of ice, sleet and snow on the collection surface of the at least one solar panel, operating the least one actuator assembly to rotate the least one panel assembly from the at least one collection orientation, and to a protective orientation, to cause the at least one collection surface to face downward toward a support surface above which the at least one panel assembly is supported to enable the at least one of ice, sleet and snow to fall away from the at least one collection surface.

14. A solar panel positioning system comprising:
at least one panel assembly comprising a solar panel and a shield, wherein:
the solar panel is of a generally elongate rectangular shape defining a collection surface to receive direct sunlight from which to generate electricity;
the shield comprises a sheet of material also of a generally elongate rectangular shape; and
the shield extends in parallel to a back surface of the solar panel that is opposite to the collection surface; and
a mounting frame comprising a horizontal component to which the at least one panel assembly is coupled for being supported above a support surface that is exposed to the sunlight, wherein the horizontal component is configured to be rotated together with the at least one panel assembly from at least one collection orientation that enables the solar panel to receive direct sunlight, and to a protective orientation that positions the shield above the solar panel to enable the shield to protect the solar panel from a falling object associated with the inclement weather.

15. The solar panel positioning system of claim 14, wherein:
the at least one collection orientation comprises multiple collection orientations to improve collection of direct sunlight through at least one of dawn to dusk of each day, and changes in elevation of the sun through multiple seasons of each year;
the solar panel positioning system comprises:
a first actuator assembly to retract a first cable coupled to the horizontal component to rotate the horizontal component together with the at least one panel assembly to a first collection orientation;
a second actuator assembly to retract a second cable coupled to the horizontal component to rotate the horizontal component together with the at least one panel assembly to a second collection orientation; and
a third actuator assembly to retract a third cable coupled to the horizontal component to rotate the horizontal component together with the at least one panel assembly to the protective orientation; and
rotating the at least one panel assembly from at least one collection orientation, and to the protective orientation comprises operating the third actuator assembly to retract the third cable while simultaneously operating at least one of the first actuator assembly and the second actuator assembly to pay out an amount of at least one of the first cable and the second cable.

16. The solar panel positioning system of claim 15, wherein:
operating the first actuator assembly to pay out an amount of the first cable comprises operating a first brake of the first actuator assembly to impose a first preselected amount of resistance on the paying out of the first cable; and
operating the second actuator assembly to pay out an amount of the second cable comprises operating a second brake of the second actuator assembly to impose a second preselected amount of resistance on the paying out of the second cable.

17. The solar panel positioning system of claim 15, wherein:
operating the first actuator assembly to pay out an amount of the first cable comprises operating a first motor of the first actuator assembly to actively pay out the first cable at a rate that imposes a preselected amount of tension on the first cable; and
operating the second actuator assembly to pay out an amount of the second cable comprises operating a second motor of the second actuator assembly to actively pay out the second cable at a rate that imposes a preselected amount of tension on the second cable.

18. The solar panel positioning system of claim 14, wherein:
each panel assembly of the at least one panel assembly comprises at least one sensor configured to detect a physical strike of the falling object on the solar panel, and to transmit an indication of the physical strike to at least one processor of the solar panel positioning system; and
the at least one processor is configured to operate at least one actuator assembly to rotate the horizontal component together with the at least one panel assembly from the at least one collection orientation and to the protective orientation in response to the indication of the physical strike.

19. The solar panel positioning system of claim 14, wherein:
each panel assembly of the at least one panel assembly comprises at least one sensor configured to detect a physical strike of the falling object on the shield, and to transmit an indication of the physical strike to at least one processor of the solar panel positioning system; and
the at least one processor is configured to operate to delay operating at least one actuator assembly to rotate the horizontal component together with the at least one panel assembly back to the at least one collection orientation from the protective orientation in response to the indication of the physical strike.

20. The solar panel positioning system of claim 14, wherein:
the shield of the at least one panel assembly comprises a sheet of metallic material or other thermally conductive material;
the at least one panel assembly further comprises an electronic device that electrically coupled to the solar panel, and is physically coupled to the shield to use the shield as a heatsink; and
the electronic device comprises at least one of:
a DC to AC inverter; and
a bypass device that enables a flow of electric current from at least one other solar panel to bypass the solar panel.
